(19) United States
(12) Patent Application Publication
(10) Pub. No.: US 2024/0104106 A1
(43) Pub. Date: Mar. 28, 2024

(54) DATA EXTRACTION CYCLES WITH MULTIPLE PARSING FRAMES

(71) Applicant: Oxylabs, UAB, Vilnius (LT)

(72) Inventor: Tadas MALINAUSKAS, Vilnius (LT)

(73) Assignee: Oxylabs, UAB, Vilnius (LT)

(21) Appl. No.: 17/954,008

(22) Filed: Sep. 27, 2022

(51) Int. Cl. G06F 16/2458

(52) U.S. Cl. CPC G06F 16/2465

(57) ABSTRACT

A parsing facility within a service provider infrastructure can navigate through source documents of target web pages and mine a specific list of target data by utilizing multiple parsing frames received from an external computing resource and/or system. The parsing facility receives a series of a plurality of parsing frames at random intermittent intervals. The parsing facility can store each of the plurality of parsing frames within its internal storage and learns the differences between each of the plurality of parsing frames. After learning the differences, the parsing facility can recognize appropriate parsing frames to locate and mine each target data from the source documents. The parsing facility can mine data from source documents by using each of the plurality of parsing frames for every mining cycle, thereby effectively managing the reception and usage of multiple parsing frames without any errors or faults.

### FIELD

The disclosure belongs to the field of web scraping and parsing technology. Embodiments disclosed herein relate generally to methods and systems to extract data from source documents by using multiple sets of data extraction guidelines.

### BACKGROUND

The automated gathering of data from the internet is commonly referred to as web scraping. Alternatively, the practice of web scraping has been more commonly known as screen scraping, data mining, web harvesting, data procurement, data collection or other similar variations. In theory, web scraping is the process of gathering data through any means other than a program interacting with an API or, obviously, through a human using a web browser. Thus, web scraping is typically accomplished by writing an automated computer program that queries at least one or more web servers, procures data from the web servers (usually in the form of the HTML, or other file formats that comprises web pages), and parses the procured data to extract the relevant information. In practical implementation, web scraping comprises a wide variety of programming methods and tools/technologies.

Web scrapers are programs written for web scraping that can have significant advantage over other means of accessing information, like web browsers. The latter are designed to present the information in a readable way for humans, whereas web scrapers are excellent at collecting and processing large amounts of data quickly. Rather than opening one page at a time through a monitor (as web browsers do), web scrapers are able to procure, process, aggregate and present large databases consisting of thousands or even millions of pages at once.

To wit, a web scraper is a specialized tool designed to procure data from web servers accurately and efficiently. Web scrapers can vary immensely in design and complexity depending on the implementation and scraping client/customer requirements. Currently, several kinds of web scrapers are available that can be utilized to suit the needs of different scraping clients/customers.

Web scraping at its basic level, comprises the following steps: a) receive one or more URLs of target web servers from scraping client/customer; b) generate and query the target web servers; c) collect the HTMLs from the web servers; d) parse, reformat and organize the collected data (in this case, the HTMLs); e) save the parsed data in a database and/or forward the parsed data to the scraping client/customer. Needless to mention that most recent web scrapers often employ the service of proxy servers to aid the process of collecting or procuring data from the target web server. As a result, most contemporary web scrapers are designed to intelligently manage and deploy proxy servers for the purpose of web scraping. In general, there are two essential modules of a web scraper—a module for composing HTTP queries and another one responsible for parsing information from the procured raw HTMLs.

Parsing or data parsing is another subject that is relevant to web scraping. In general, parsing is a method for structuring and extracting vast amounts of raw data. Technically, parsing refers to the process of converting one or more strings of data into a different type of data. For example, raw HTML codes can be converted into a more readable data format using paring techniques. To wit, data parsing is the process of transforming a sequence (i.e., unstructured data) into a parse tree (i.e., structured data) that is easier to read, understand and use. Parsing processes are commonly carried out to ease the extraction of specific data from raw HTML codes.

Parsing processes can transform a sequence of characters (unstructured data) into a series of tokens. In simple words, the parser turns the meaningless strings of data into a flat list of data such as “number literal”, “string literal” or “identifier” and can recognize reserved identifiers (i.e., keywords) and discard whitespaces. Furthermore, parsing processes can process the aforesaid tokens, arrange/organize the tokens into structures, (such as, for example, a parse tree) and establish relationships between the elements of the said parse tree. To summarize, data parsing cleans and arranges the data into a structured format containing only the relevant information that can be exported in, for example, JSON, CSV, or any other format.

As previously mentioned, contemporary web scrapers often employ proxy servers to facilitate the process of web scraping. Employing proxy servers or a pool of proxy servers can traverse the problem of being detected by the target web servers. In addition, proxy servers enable web scrapers to query and procure region-specific data from the target web servers. One must understand that the term proxy refers to an intermediary server that routes the queries originated from web scrapers using its IP addresses (i.e., proxy's IP address) to the target web servers. Therefore, the target website can only know the IP address of the proxy server but not the IP address of the web scraper.

It would be appropriate here, to diverge to the subject of proxy servers. By definition, proxy servers are intermediary network nodes for delivering network communications between proxy users and intern services. Proxy users can send their network traffic to the target web servers via proxy servers. Furthermore, proxy users can obfuscate their actual IP addresses when employing proxy servers to send and receive network traffic to target websites via proxy servers. Besides providing online anonymity, proxy servers can be useful in traversing internet censorship. For instance, the internet can be censored and/or restricted by internet providers and/or government entities in certain parts of the world. In such instances, proxy servers can be a suitable solution to circumvent government censorship and retrieve or access information on the internet. Rather than accessing the censored website directly, accessing it through a proxy server saturated in another country makes users less likely to be found by the censoring entities.

In computer science, HTML (HyperText Markup Languages) is a standard markup language used for creating, designing and structuring data and/or documents displayed in a web page. Oftentimes, HTML can be supplemented by other programming languages such as, for example, JavaScript and CSS (Cascading Style Sheets). In simple words, HTML allows programmers and/or web designers to create and structure sections, paragraphs and links using elements, tags, and attributes. The most common use cases of HTML are but not limited to: website development, website navigation and website documentation.

In general, a website may comprise multiple different HTML documents, for example, a home page, a product page and a contact page would all have dedicated HTML files. HTML documents are, in its fundamental form, are files that end with a ‘.html’ or ‘.htm’ extension. A web browser may read, translate the HTML file and render the content of the HTML file in a human readable form. An individual HTML page can have a plurality of HTML elements, comprising of a set of tags and attributes. An HTML tag indicates where an element begins and ends, whereas an HTML attribute indicates the characteristics of an element. An HTML element can have three important parts or sections: opening tag (e.g., <p> to begin a paragraph content), content (the actual content the web users see) and closing tag (e.g., </p> to end a paragraph content). The combination of the aforementioned exemplary parts can produce an HTML element as follows: <p> an exemplary paragraph for the web user</p>.

Following the three parts of an HTML element, HTML attributes can also be an important part of an HTML element. An HTML attribute can have two sections—a name and attribute value. The name identifies the additional information that a web designer wants to include, while the attribute value provides the actual specifications of the said information. For example, <p style=“color: purple; font-family:verdana”> an exemplary paragraph for the web user. </p>. Here, the style attribute is used to define a specific type of font and color.

Returning to web scraping and data parsing, it would be relevant to describe the most critical challenges in the field of web scraping and parsing. The diversity of web page structures or layouts can significantly challenge web scraping and parsing. A web page designer may be governed by certain design or layout standards when creating a web page; therefore, different web pages may have different structures or layouts. Such vast structural or layout differences between multiple web pages can be a severe issue for certain web scrapers and parsers, which may have been initially configured for scraping and parsing only a few web page structures or layouts. Employing such scraping and parsing technologies on web pages of different structures or layouts can cause errors, substantial loss of resources (such as but not limited to time, human resources and financial resources) and poor customer experiences.

Returning to web scraping and data parsing, it would be relevant to describe the most critical challenges in the field of web scraping and parsing. Diversity in web page structures or layouts can significantly challenge web scraping and parsing. A web page designer may be governed by certain design or layout standards when creating a web page; therefore, different web pages may have different structures or layouts. Moreover, the web page designer may continuously change the structure or layout to accommodate new data or enhance the user experience. Such continuous structural and layout changes on a web page can be a severe challenge for web scraping and parsing technologies, which may be originally configured to parse and extract data from the web page based on the initial structure or layout of the web page. To overcome such challenges, typically, a parser must be completely re-configured whenever a structural or layout change occurs on the web page. However, such a task is time and resource-consuming and affects the overall quality of customer service.

Therefore, the current disclosure facilitates the configuration of a parsing platform effectively and economically whenever structural or layout changes occur on a web page.

### SUMMARY

The summary provided herein presents a general understanding of the exemplary embodiments disclosed in the detailed description accompanied by drawings. Moreover, this summary is not intended as an extensive or exhaustive overview. Instead, the only purpose of this summary is to present the condensed concepts related to the exemplary embodiments in a simplified form as a prelude to the detailed description.

Systems and methods to effectively manage data extraction processes are disclosed. In one embodiment, a parsing facility is configured to receive a plurality of parsing frames in intermittent successions from at least one external computing source/system. The interval between the reception of each parsing frame may be intermittent or irregular for each data procurement project. In one embodiment, the parsing facility is configured to store each of the plurality of parsing frames within its internal storage. Further, the parsing facility analyzes each of the plurality of parsing frames and learns the differences between each parsing frame. Upon learning the differences, the parsing facility uses the plurality of parsing frames to locate target fields in the source documents of the target web pages. Ultimately, the parsing facility extracts target data corresponding to the target fields from the source documents. In the current disclosure, systems and methods are disclosed to enable the parsing facility to execute cycles of data extraction processes by utilizing at least more than one parsing frame without compromising precision.

### BRIEF DESCRIPTION OF THE DRAWINGS

FIG. 1 shows an architectural block diagram of several exemplary embodiments disclosed herein.

FIGS. 2A-2C are exemplary sequence flow diagrams showing how parsing facility 106 may execute data extraction processes belonging to a data procurement project by utilizing a plurality of parsing frames.

FIG. 3 illustrates a computing system 300 in which a computer-readable medium 303 may provide instruction for performing any methods and processes disclosed herein.

### DETAILED DESCRIPTION

The following detailed description is provided below along with accompanying figures to illustrate the core aspects of the embodiments disclosed herein. While one or more aspects of the embodiments are described, it should be understood that the described aspects are not limited to any one embodiment. On the contrary, the scope of the present embodiments are only limited by the claims and furthermore, the disclosed embodiments may encompass numerous alternatives, modifications and equivalents. For the purpose of example, several details are described in the following description in order to give a comprehensive understanding of the present embodiments. A person of ordinary skills in the art will understand that the described embodiments may be implemented or practiced according to the claims without some or all of these specific details. In addition, standard or well-known methods, procedures, components and/or systems have not been described in detail so as not to obscure the crucial parts of the disclosed exemplary embodiments.

The term “one embodiment”, “an embodiment”, “an exemplary embodiment” etc., as used in the current disclosure, imply that the embodiment described may comprise a particular aspect, attribute, or feature, but every embodiment may not necessarily comprise the particular aspect, attribute, or feature. In addition, such terms are not necessarily implying the same embodiment. Furthermore, when a particular aspect, attribute or feature is disclosed in association with an embodiment, it is suggested that it is within the knowledge of one skilled in the art to affect such aspect, attribute or feature in association with other embodiments whether or not explicitly disclosed.

Some general terminology descriptions may be helpful and are included herein for convenience and are intended to be interpreted in the broadest possible interpretation. Elements or entities that are not imperatively defined in the description should have the meaning as would be understood by a person skilled in the art.

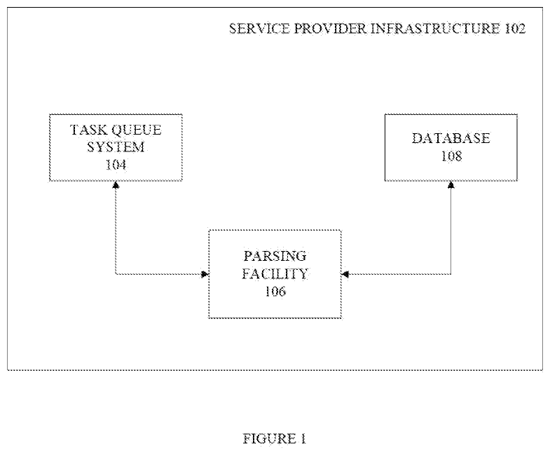

Service provider infrastructure 102 (SPI 102) may be a combination or collection of computing resources/systems comprising the platform or infrastructure that offers data procurement services (i.e., web data collection) to multiple clients. A data procurement service may comprise but is not limited to collecting data from at least one target web page, parsing the collected data and extracting specific target data upon parsing. SPI 102, as shown in FIG. 1, may comprise an exemplary instance of task queue system 104, parsing facility 106 and database 108. However, in actual implementation, SPI 102 may comprise additional computing resources/systems that are not shown in FIG. 1. For example, SPI 102 may comprise but is not limited to scraping engines and/or data collection resources/systems, infrastructural gateways, APIs, DNS servers, proxy rotators, storage facilities and proxy servers that are necessary for supporting the execution of data procurement services. SPI 102 may also be based on cloud computing infrastructures in some embodiments.

Task queue system 104 may be a distributed and durable computing resource that offers a scalable queueing and streaming infrastructure capable of continuously ingesting gigabytes of data per second from several computing resources/systems of SPI 102. The ingested data are then made available in milliseconds to specific computing resources/systems of SPI 102 that can read, fetch and react to the data present within task queue system 104. For instance, task queue system 104 may receive multiple source documents belonging to a plurality of target web pages from a computing resource/system present within SPI 102. These source documents are then arranged in separate queues, each dedicated to a specific target domain (e.g., a queue dedicated to web pages of www.exampledomain1.com and another to web pages of www.exampledomain2.org). In some embodiments, the source documents arranged within task queue system 104 may be fetched by parsing platform 104 for executing, but not limited to, data extraction processes. Task queue system 104 may be present within SPI 102; however, in some exemplary embodiments, task queue system 104 may be external to SPI 102 or based on a cloud computing platform. Furthermore, in some embodiments, task queue system 104 may also receive and queue up data from parsing facility 106. For instance, parsing facility 106 may send back the previously fetched source document in the event of a failed data extraction process. The source document returned by parsing platform 106 may be stored in a different queue dedicated to failed data extraction processes. A person of ordinary skill in the art will understand that task queue system 104 may comprise multiple internal sections where different types of data (such as, for example, but not limited to, source documents of target web pages) are queued up.

Parsing platform 106 may be a computing resource/system or a collection of computing resources/systems responsible primarily for executing multiple parsing and data extraction processes. In some embodiments, parsing platform 106 may access task queue system 104 and fetch each of the several source documents sequentially. Furthermore, parsing platform 106 may be capable of navigating through each source document and locating specific target fields in each source document with the aid of parsing frames. Upon locating each target field, parsing platform 106 may extract target data corresponding to the target fields and send them (i.e., the target data) to database 108 for storage. Further still, in some embodiments, parsing platform 106 may be capable of receiving multiple parsing frames at intermittent successions from at least one computing resource/system external to SPI 102. Parsing platform 106 may also be capable of storing the multiple parsing frames within its internal storage facility. In the current embodiments, parsing platform 106 may be present within SPI 102; however, in some embodiments, parsing platform 106 may be located external to SPI 102 or be based on cloud technologies. Parsing platform 106 may intelligently organize, manage and use multiple parsing frames to extract target data from multiple source documents with scrupulous precisions. Further information regarding parsing platform 106 is elaborated in later sections of the current disclosure.

Database 108 may be a conglomeration of computer resources and storage devices capable of storing a plurality of organized collection of structured information or data, including but not limited to parsed data and their respective metadata. In some embodiments, database 108 may continuously receive and store a plurality of target data extracted from source documents and their respective metadata from parsing platform 106. The stored parsed data and their respective metadata may then be fetched by at least one or more computing resources/systems of SPI 102 and delivered to specific clients (especially to client devices operated by clients) via an external network such as, but not limited to, the internet.

In the current disclosure, target web pages may refer to those web pages from which SPI 102 may be required to extract specific data in order to accomplish a particular data procurement project. Likewise, the term source document may refer to the document containing the source codes that were used to structure a target web page and its contents. In the current disclosure, the source documents may be in several formats, for example, but not limited to HTML, CSS, JavaScript, JSON and XML. In the same context, the term target field may refer to specific data fields or tags emplaced within the source documents and pointing to specific data that must be extracted from the source documents. Knowing the emplacements of each target field may be necessary to extract the specific data from the source documents. Also, the term extraction metadata in the current disclosure refers to a set of data providing information regarding the data extraction process.

FIG. 1 shows an architectural block diagram of several exemplary embodiments disclosed herein. Especially, FIG. 1 shows an exemplary instance of SPI 102 comprising at least one task queue system 104, parsing platform 106 and database 108. SPI 102 may manage, execute and accomplish several distinct data procurement projects. The data procurement projects managed and executed by SPI 102 may be accomplished as a service to one or more clients.

In the current embodiments, a data procurement project may be a collection of different processes such as, but not limited to, data collection, data parsing and data extraction. A client may operate a client device (not shown) by which the client may submit data procurement request(s) to SPI 102 via a network (for example, the internet). SPI 102 may consider each data procurement request as an individual project. Thus, a data procurement project may require SPI 102 to procure specific data (hereinafter referred to as target data) from at least one target web page and deliver them (i.e., the target data) to the client.

As will be apparent to those skilled in the art, SPI 102 may comprise additional or supplementary computing resources/systems that are not shown in FIG. 1. For instance, SPI 102 may comprise additional computing resources/systems responsible for, but not necessarily limited to: (a) communicating with one or more client devices (not shown); (b) performing data collection processes (i.e., collecting the source documents of target web pages); (c) choosing and deploying proxy servers to access target web pages; (d) storing vast amounts of data. Furthermore, FIG. 1 should be considered an exemplary representation only and does not limit the disclosed embodiments in any way. In addition or alternatively, in some instances, computing resources/systems present within SPI 102 may have different titles or be combined to form a unitary resource/system. However, such an arrangement may not modify the overall functionalities of SPI 102.

In FIG. 1, task queue system 104 and parsing platform 106 may communicate and exchange data with each other. Likewise, parsing platform 106 and database 108 may communicate and exchange data with each other. In some embodiments shown in FIG. 1, task queue system 104, parsing platform 106 and database 108 may communicate and exchange data with other computing resources/systems of SPI 102 that are not shown in FIG. 1.

In an exemplary embodiment shown in FIG. 1, in one instance, for example, at the commencement of a data extraction process, parsing platform 106 may receive a parsing frame (for convenience, hereinafter referred to as the first parsing frame) from at least one external source such as but not limited to, a computing resource/system operated by, for example, a human administrator of SPI 102. It should be understood that the computing resource/system may be external to SPI 102, therefore not shown in FIG. 1. Parsing platform 106 may receive and store the first parsing frame within its internal storage.

In the embodiments of the current disclosure, a parsing frame may be composed manually by an external agent, such as not limited to the aforementioned human administrator of SPI 102. Furthermore, a parsing frame may be but is not limited to a collection of codes and navigational guidelines for parsing platform 106 to navigate through each source document and locate several target fields in them. Especially, a parsing frame may comprise but is not limited to a list of target fields, with each target field coupled with a distinct string of code(s) and/or navigational guideline(s) that may aid parsing platform 106 in locating the target fields in the source documents of the target web pages. In addition, or alternatively, a parsing frame may reflect the emplacements of target fields in each source document of the target web pages.

Upon receiving and storing the first parsing frame, parsing platform 106 may access task queue system 104 and fetch one of the several source documents from a queue of source documents dedicated to multiple target web pages of a particular web domain. In some embodiments, parsing platform 106 may query task queue system 104 to receive the source document mentioned above. Following the fetching of a source document from task queue system 104, parsing platform 106 may refer to and use the first parsing frame to navigate through the currently fetched source document and ultimately locate each of the several target fields mentioned in the first parsing frame. Once the target fields are located, parsing platform 106 may extract target data corresponding to each target field from the currently fetched source document.

The target data extracted from the currently fetched source document may be sent to database 108 by parsing platform 106 for storage. However, before sending the target data to database 108, parsing platform 106, in some embodiments, may convert the target data to necessary format and produce a set of extraction metadata. Ultimately, parsing platform 106 may send the target data in an appropriate format coupled with the set of extraction metadata to database 108 for storage. In this way parsing platform 106 completes a cycle of data extraction process belonging to a data procurement project. In addition, the above described data extraction cycle may also be referred to as a single frame extraction cycle.

Subsequently, parsing platform 106 may execute the single frame extraction cycle repeatedly. For each cycle, parsing platform 106 may fetch a source document successive to the previously fetched source document. It should be recalled that parsing platform 106 may fetch the source documents from a queue present in task queue system 104, as described in the earlier sections. Therefore for each execution of the data extraction cycle, parsing platform 106 may extract target data from different source documents belonging to different target web pages of a particular web domain.

However, parsing platform 106 may temporarily halt or suspend the execution of the single frame extraction cycle, when parsing platform 106 may receive a new parsing frame from the external source. Therefore, in an exemplary embodiment, after the reception of the first parsing frame, at a random juncture, parsing platform 106 may receive a new parsing frame (for convenience referred to as the second parsing frame) from the previously mentioned external source such as but not limited to, a computing resource/system operated by, for example, a human administrator of SPI 102. Similar to the first parsing frame, the second parsing frame may also be composed by the human administrator of SPI 102 mentioned earlier.

The reception of a new parsing frame (in the current example, the second parsing frame) by parsing platform 106 may indicate or imply at least one of the following:
(a) at least one target field whose emplacement has been changed in source documents. Therefore using the codes or navigational guidelines mentioned in the previous parsing frame to locate such target field(s) will lead to errors in the data extraction processes.
(b) target data corresponding to a new target field or fields must be extracted from the source documents.

Therefore, in the current exemplary instance, the second parsing frame may comprise at least one new string of code(s) or navigational guidelines(s) coupled with at least one target field whose emplacement has been changed in the source documents of the target web pages.

After receiving the second parsing frame, parsing platform 106 may temporarily stop executing the single frame extraction cycles and may proceed to analyze the second parsing frame. Accordingly, parsing platform 106 may analyze the second parsing frame and learn the difference(s) between the second and the first parsing frames. In addition, parsing platform 106 may store the second parsing frame within its internal storage. After analyzing and learning the difference(s), parsing platform 106 may begin executing the data extraction process. Specifically, parsing platform 106, after fetching a source document from task queue system 104, may refer to and use the parsing frames received hitherto, i.e., both the first and second parsing frames, to navigate through the currently fetched source document and locate the target fields.

More specifically, parsing platform 106 may refer to and use the second parsing frame to navigate and locate the target field(s) whose emplacements have been changed in the source documents. However, parsing platform 106 may refer to and use the first parsing frame to locate the rest of the target fields (or the target fields whose emplacements were not changed in the source documents). Once the target fields are located, parsing platform 106 may extract target data corresponding to each target field from the currently fetched source document.

The target data extracted from the currently fetched source document may be sent to database 108 by parsing platform 106 for storage. However, before sending the target data to database 108, parsing platform 106, in some embodiments, may convert the target data to necessary format and produce a set of extraction metadata. Ultimately, parsing platform 106 may send the target data in an appropriate format coupled with the set of extraction metadata to database 108 for storage. In this way, parsing platform 106 completes a cycle of the data extraction process belonging to a data procurement project by utilizing two parsing frames. Such a data extraction cycle may be referred to as a multi-frame extraction cycle.

Parsing platform 106 may continue to execute the multi-frame extraction cycle in a repeated manner. For each multi-frame extraction cycle, parsing platform 106 may fetch a source document successive to the previously fetched source document. Therefore for each execution of the data extraction cycle, parsing platform 106 may extract target data from different source documents belonging to different target web pages of a particular web domain.

However, parsing platform 106 may temporarily halt or suspend the execution of the multi-frame extraction cycle as described above when parsing platform 106 may receive yet another new parsing frame from the external source. In such instances, parsing platform 106 may analyze the newly received parsing frame and learn the differences between the newly received and the previously received frames. Following this, parsing platform 106 may navigate through individual source documents and locate each of the several target fields by referring to and using the plurality of parsing frames received hitherto.

In this way, parsing platform 106 may continue to extract data from multiple source documents by receiving a series of a plurality of parsing frames at random intermittent intervals. Particularly, parsing platform 106, at an exemplary instance (for example, at the commencement of a data extraction process), may receive a first parsing frame followed by a series of a plurality of parsing frames to carry out the data extraction process without compromising accuracy. Moreover, as described above, parsing platform 106 may continue to analyze and learn the differences between each parsing frame to locate target fields in the source documents accurately. Parsing platform 106 may recognize appropriate parsing frames to locate each target field. By analyzing and learning the differences between each parsing frame, parsing platform 106 may recognize the target fields whose emplacements were changed in the source documents and the appropriate parsing frame(s) to locate such target fields in the source documents. In addition, parsing platform 106 may also recognize the appropriate parsing frame(s) to locate the target fields whose emplacements were not changed in the source documents.

Thus the current embodiment, in one aspect, may allow parsing platform 106 to efficiently execute data extraction processes with precision by utilizing a plurality of parsing frames. In another aspect, the current embodiment may enable parsing platform 106 to be more flexible and reliable at the same time. Especially, the current embodiment may permit parsing platform 106 to process multiple parsing frames simultaneously and utilize multiple parsing frames to extract target data from several source documents to accomplish a particular data procurement project. In yet another aspect, the current embodiment may cause parsing platform 106 to execute data extraction processes errorless, irrespective of changes occurring in the source documents.

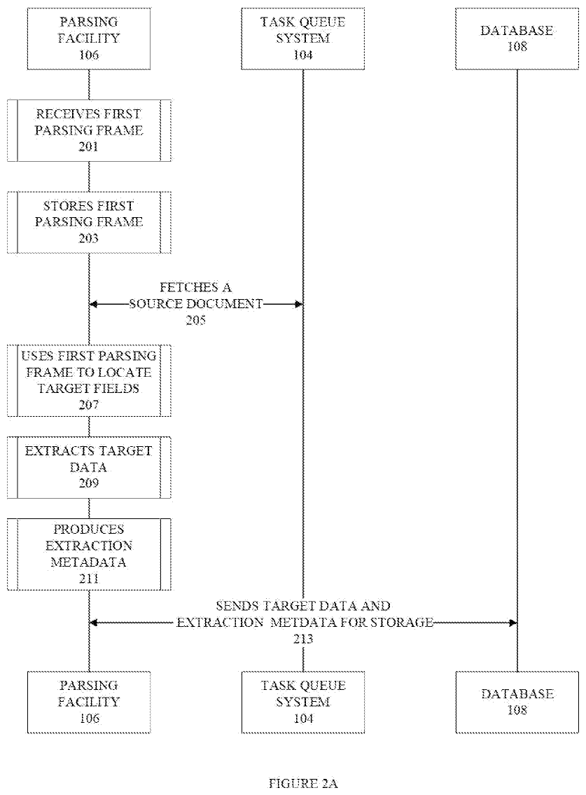

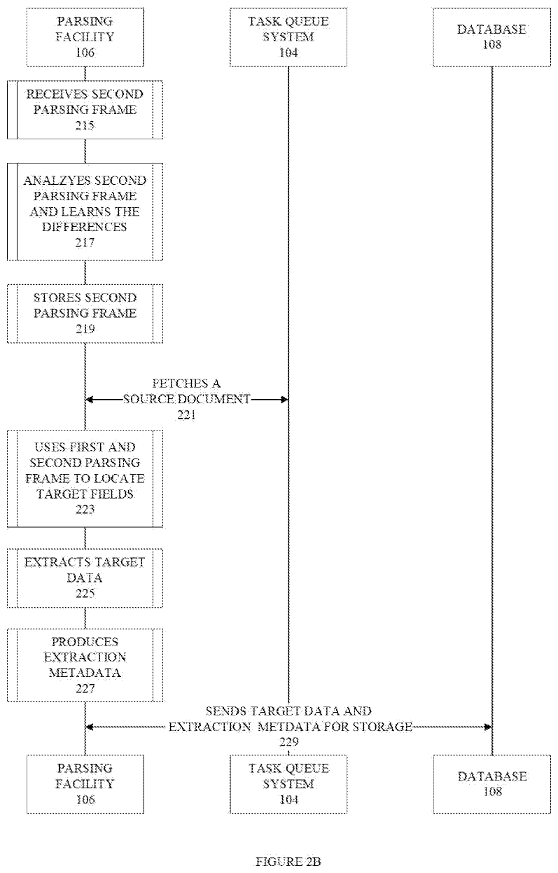

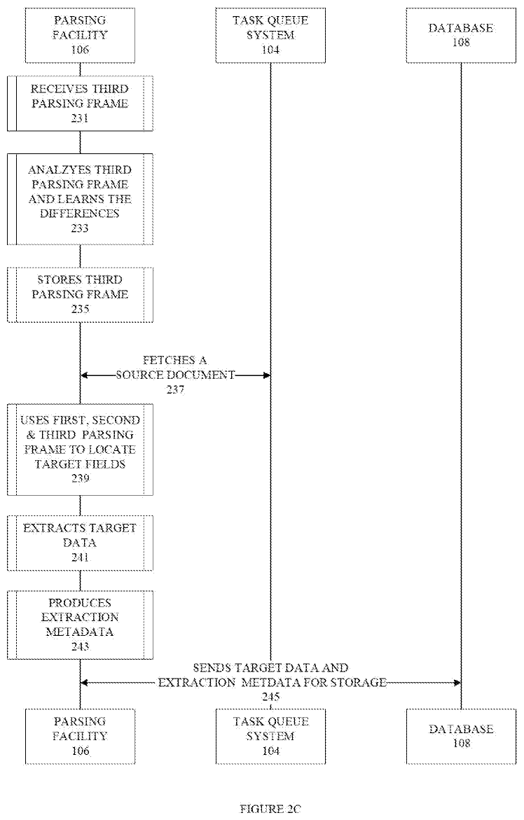

FIGS. 2A-2C are exemplary sequence flow diagrams showing how parsing platform 106 may execute data extraction processes belonging to a data procurement project by utilizing a plurality of parsing frames. In order to actuate parsing platform 106 in executing data extraction processes, a parsing frame must be sent to parsing platform 106. Therefore, the sequence flow diagrams of FIGS. 2A-2C begins with step 201, wherein parsing platform 106 receives a first parsing frame from an external source such as but not limited to, a computing resource/system operated by, for example, a human administrator of SPI 102.

In the current exemplary embodiment, in general, a parsing frame is but not limited to a collection of code(s) and navigational guideline(s) for parsing platform 106 to navigate through each source document and locate several target fields. Further, a parsing frame comprises but not limited to a list of target fields, with each target field coupled with a distinct string of code(s) and/or navigational guideline(s) that may aid parsing platform 106 in locating the target fields in the source documents of the target web pages. To simply put, a parsing frame reflects the emplacements of target fields in each source document of the target web pages of a particular web domain.

In the current exemplary embodiment, for example, the first parsing frame may resemble as follows:

```
first name
  //input[@id= “firstnamereg - firstname”]
last name
  //input[@id = “lastnamereg - lastname”]
address
  //input[@id = “contactinfro - address”]
```

The exemplary parsing frame comprises target fields such as ‘first name’, ‘last name’ and ‘address’ with each of the aforesaid target fields coupled with a stirring of code(s) and navigational guideline(s), which aids parsing platform 106 to locate the target fields mentioned above in the source documents. However, one must understand that the above parsing frame shown is only for the sake of an example. In actuality, different target fields, codes and navigational guidelines may be present. Also, the number of target fields may differ in an actual parsing frame.

Following step 201, in step 203, parsing platform 106 stores the first parsing frame within its storage. In step 205, parsing platform 106 access task queue system 104 and fetches a source document from a queue dedicated to the source documents of multiple target web pages belonging to a particular web domain. In step 207, parsing platform 106 retrieves the first parsing frame from its internal storage and uses it to navigate through the currently fetched source document and ultimately locates each target field.

In step 209, parsing platform 106 extracts the target data corresponding to the target fields from the currently fetched source document. Following step 209, in step 211, parsing platform 106 produces a set of extraction metadata. Additionally, in some embodiments, parsing platform 106 may also convert the target data into appropriate formats. Consequently, in step 213, parsing platform 106 sends the target data in an appropriate format coupled with the set of extraction metadata to database 108 for storage. In this way parsing platform 106 completes a cycle of data extraction process (steps 205-213) belonging to a data procurement project. In addition, the above described data extraction cycle may also be referred to as a single frame extraction cycle.

Following step 213, parsing platform 106 continues to execute the single frame extraction cycle (steps 205-213) repeatedly. However, during each repetition, parsing platform 106 fetches a source document successive to the previously fetched source document from task queue system 102. Therefore, during each of the several data extraction cycles, parsing platform 106 may extract target data from different source documents belonging to different target web pages of a particular web domain.

In the current exemplary embodiment, at a random juncture, after executing at least one cycle of the single frame extraction cycle, parsing platform 106 receives a second parsing frame (shown in step 215) from the external source such as, but not limited to, a computing resource/system operated by, for example, a human administrator of SPI 102. The time interval between the repetition of the first and second parsing frame may fluctuate and vary for each data procurement project.

Following the reception of the second parsing frame, parsing platform 106 may temporarily stop executing the single frame extraction cycle (steps 205-213) and in step 217, parsing platform 106 analyzes the second parsing frame and learns the differences between the first and second parsing frames. In step 219, parsing platform 106 stores the second parsing frame within its internal storage. In the current exemplary embodiment, for example, the second parsing frame may resemble as follows:

```
first name
  //input[@id= “name - firstname”]
last name
  //input[@id = “lastnamereg - lastname”]
address
  //input[@id = “contactinfro - address”]
```

The exemplary second parsing frame comprises similar target fields as the first parsing frame, however, the string of code(s) and navigational guideline(s) coupled with the target field ‘first name’ has been changed. This signifies that the emplacement of the target field ‘first name’ has been changed or modified in the source documents of the target web pages.

Following this, in step 221, parsing platform 106 accesses task queue system 102 and fetches a source document from the queue mentioned previously. In step 223, parsing platform 106 retrieves the first and second parsing frame from its internal storage, navigates through the currently fetched source document, and locates each target field. Specifically, parsing platform 106 uses the second parsing frame to locate the target field whose emplacements were changed or modified in the source documents. Therefore, in the current example, parsing platform 106 uses the second parsing frame to locate the target field ‘first name’. However, parsing platform 106 uses the first parsing frame to locate the rest of the target fields, such as ‘last name’ and ‘address’ (i.e., the target fields whose replacements were not changed in the source documents).

Though the second parsing frame comprises similar target fields to the first parsing frame, parsing platform 106 is configured in such a way that it utilizes the second parsing frame to identify only the target fields whose emplacements were changed in the source document. To wit, parsing platform 106 is configured to use each of the plurality of the subsequent parsing frames to identify each target field whose emplacements were changed in the source document subsequently. Also, it is essential to understand that the parsing platform 106, when learning the differences between the first and the second parsing frame, learns about the target fields whose emplacements were changed in the source documents; therefore, parsing platform 106 is able to ascertain which parsing frame to use in order to identify each target fields.

In step 225, parsing platform 106 extracts the target data corresponding to each target field from the currently fetched source document. In step 227, parsing platform 106 produces a set of extraction metadata. Additionally, in some embodiments, parsing platform 106 may also convert the target data into appropriate formats. Consequently, in step 229, parsing platform 106 sends the target data in an appropriate format coupled with the set of extraction metadata to database 108 for storage. In this way, parsing platform 106 completes a cycle of the data extraction process belonging to a data procurement project by utilizing two parsing frames (221-229). Such a data extraction cycle may be referred to as a multi-frame extraction cycle.

Following step 229, parsing platform 106 continues to execute the multi-frame extraction cycle (steps 221-229) repeatedly. However, during each repetition, parsing platform 106 fetches a source document successive to the previously fetched source document from task queue system 104. Therefore, during each of the several data extraction cycles, parsing platform 106 may extract target data from different source documents belonging to different target web pages of a particular web domain.

In the current exemplary embodiment, at a random juncture, after executing at least one cycle of the multi-frame extraction cycle, parsing platform 106 receives a third parsing frame (shown in step 231) from the external source such as, but not limited to, a computing resource/system operated by, for example, a human administrator of SPI 102. The time interval between the repetition of the second and third parsing frame may fluctuate and vary for each data procurement project.

Following the reception of the third parsing frame, parsing platform 106 may temporarily stop executing the multi-frame extraction cycle (steps 221-227) and in step 233, parsing platform 106 analyzes the third parsing frame and learns the differences between the first second and third parsing frames. In step 235, parsing platform 106 stores the third parsing frame within its internal storage. In the current exemplary embodiment, for example, the third parsing frame may resemble as follows:

```
first name
  //input[@id= “name - firstname”]
last name
  //input[@id = “lastnamereg - lastname”]
address
  //input[@id = “location-info - address”]
```

The exemplary third parsing frame comprises similar target fields as the first and second parsing frames, however, the string of code(s) and navigational guideline(s) coupled with the target field ‘address’ has been changed. This signifies that the emplacement of the target field ‘address’ has been changed or modified in the source documents of the target web pages.

Following this in step 237, parsing platform 106 accesses task queue system 104 and fetches a source document from the queue mentioned previously. In step 239, parsing platform 106 retrieves the first, second and third parsing frame from its internal storage, navigates through the currently fetched source document, and locates each target field. Specifically, parsing platform 106 uses the third parsing frame to locate the target field whose emplacements were changed or modified in the source documents. Therefore, in the current example, parsing platform 106 uses the third parsing frame to locate the target field ‘address’. However, parsing platform 106 uses the first and second parsing frame to locate the rest of the target fields, such as ‘last name’ and ‘first name respectively (or in other words the target fields whose replacements were not changed in the source documents).

In step 241, parsing platform 106 extracts the target data corresponding to each target field from the currently fetched source document. In step 243, parsing platform 106 produces a set of extraction metadata. Additionally, in some embodiments, parsing platform 106 may also convert the target data into appropriate formats. Consequently, in step 245, parsing platform 106 sends the target data in an appropriate format coupled with the set of extraction metadata to database 108 for storage. In this way, parsing platform 106 completes a cycle of the data extraction process belonging to a data procurement project by utilizing three parsing frames (237-245). Such a data extraction cycle may be referred to as a multi-frame extraction cycle.

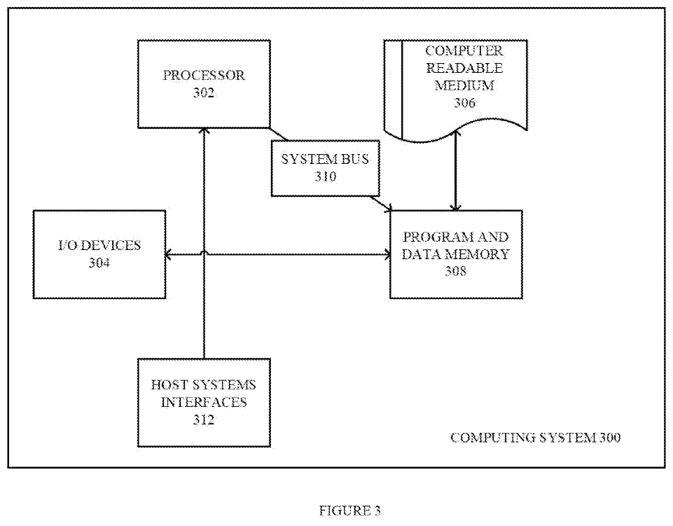

The embodiments herein may be combined or collocated in a variety of alternative ways due to design choice. Accordingly, the features and aspects herein are not in any way intended to be limited to any particular embodiment. Furthermore, one must be aware that the embodiments can take the form of hardware, firmware, software, and/or combinations thereof. In one embodiment, such software includes but is not limited to firmware, resident software, microcode, etc. FIG. 3 illustrates a computing system 300 in which a computer-readable medium 303 may provide instruction for performing any methods and processes disclosed herein.

Furthermore, some aspects of the embodiments herein can take the form of a computer program product accessible from the computer-readable medium 306 to provide program code for use by or in connection with a computer or any instruction execution system. For the purposes of this description, the computer-readable medium 306 can be any apparatus that can tangibly store the program code for use by or in connection with the instruction execution system, apparatus, or device, including the computing system 300.

The computer-readable medium 306 can be any tangible electronic, magnetic, optical, electromagnetic, infrared, or semiconductor system (or apparatus or device). Some examples of a computer-readable medium 306 include solid-state memories, magnetic tapes, removable computer diskettes, random access memories (RAM), read-only memories (ROM), magnetic disks, and optical disks. Some examples of optical disks include read-only compact disks (CD-ROM), read/write compact disks (CD-R/W), and digital versatile disks (DVD).

The computing system 300 can include one or more processors 302 coupled directly or indirectly to memory 308 through a system bus 310. The memory 308 can include local memory employed during actual execution of the program code, bulk storage, and/or cache memories, which provide temporary storage of at least some of the program code in order to reduce the number of times the code is retrieved from bulk storage during execution.

Input/output (I/O) devices 304 (including but not limited to keyboards, displays, pointing devices, I/O interfaces, etc.) can be coupled to the computing system 300 either directly or through intervening I/O controllers. Network adapters may also be coupled to the computing system 300 to enable the computing system 300 to couple to other data processing systems, such as through host systems interfaces 312, printers, and/or storage devices through intervening private or public networks. Modems, cable modems, and Ethernet cards are just examples of network adapter types.

Although several embodiments have been described, one of ordinary skill in the art will appreciate that various modifications and changes can be made without departing from the scope of the embodiments detailed herein. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover, in this document, relational terms such as first and second, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without additional constraints, preclude the existence of additional identical elements in the process, method, article, and/or apparatus that comprises, has, includes, and/or contains the element. The terms “a” and “an” are defined as one or more unless explicitly stated otherwise herein. The terms “approximately”, “about” or any other version thereof, are defined as being close to as understood by one of ordinary skill in the art. A device or structure that is “configured” in a certain way is configured in at least that way but may also be configured in ways that are not listed. For the indication of elements, singular or plural form can be used, but it does not limit the scope of the disclosure and the same teaching can apply to multiple objects, even if in the current application an object is referred to in its singular form.

The Disclosure is provided to allow the reader to quickly ascertain the nature of the technical disclosure. It is submitted with the understanding that it will not be used to interpret or limit the scope or meaning of the claims. In addition, in the foregoing Detailed Description, it is demonstrated that multiple features are grouped together in various embodiments for the purpose of streamlining the disclosure. This method of disclosure is not to be interpreted as reflecting an intention that the claimed embodiments require more features than are expressly recited in each claim. Rather, as the following claims reflect, the inventive subject matter lies in less than all features of a single disclosed embodiment.

A method of extracting target data with precision by utilizing a plurality of parsing frames is disclosed. The method comprises:
(a) receiving, by a parsing platform present within a service provider infrastructure, a first parsing frame specifying to the parsing platform how to locate a list of target fields in at least one source document of a target, wherein the first parsing frame is received from an external computing resource prior to executing at least one cycle of data extraction process;
(b) executing, by the parsing platform, at least one cycle of a data extraction process by utilizing the first parsing frame;
(c) receiving, by the parsing platform, a second parsing frame from the at least one external computing resource, wherein the parsing platform receives the second parsing frame at a random instance following the at least one cycle of data extraction process;
(d) analyzing, by the parsing platform, the at least one new parsing frame, to identify a difference between the first parsing frame and the second parsing frame;
(e) utilizing, by the parsing platform, the first parsing frame and the difference identified in (d) to execute the at least one data extraction process, wherein the utilizing (e) comprises (i) utilizing the second parsing frame to locate a target field whose emplacement has been changed in the at least one source document and (ii) utilizing the first parsing frame to locate a target field whose emplacement has not been changed in the at least one source document.

Any of the methods above are disclosed wherein the executing (b) comprises:
fetching, by the parsing platform, the at least one source document from a queue of source documents;
locating, by the parsing platform, individual target fields from the list of target fields in the at least one source document;
extracting, by the parsing platform, target data corresponding to the individual target fields from the list of target fields from the at least one source document; and
sending, parsing platform, the target data corresponding to the individual target fields to a database.

Any of the methods above are disclosed wherein the first parsing frame comprises the list of target fields with the individual target fields coupled with a distinct string of code or a navigational guideline to aid parsing platform in locating the individual target fields in the at least one source document of the target.

Any of the methods above are disclosed wherein the first parsing frame is composed by an agent that is external to the service provider infrastructure.

Any of the methods above are disclosed wherein the external computing resource is operated by at least one administrator of the service provider infrastructure.

Any of the methods above are disclosed further comprising repeating the at least one cycle of data extraction process by utilizing the first parsing frame until the parsing platform receives the at least one new parsing frame.

Any of the methods above are disclosed further comprising fetching, by the parsing platform, at least one successive source document from the queue of source documents for each repetition of the at least one cycle of data extraction process by utilizing the first parsing frame.

Any of the methods above are disclosed wherein the reception of the second parsing frame by the parsing platform signifies at least one of:
(i) the target field whose emplacement has been changed in the at least one source document, or
(ii) a target data corresponding to a new target field.

Any of the methods above are disclosed wherein the second parsing frame comprises a new string of code or a navigational guideline coupled with the target field whose emplacement has been changed in the source documents of the target web pages.

Any of the methods above are disclosed wherein the second parsing frame is composed by the agent that is external to the service provider infrastructure.

Any of the methods above are disclosed further comprising storing, by the parsing platform, the first parsing frame and the second parsing frame within an internal storage available in the parsing platform.

Any of the methods above are disclosed further comprising sending, by the parsing platform, the target data and extraction metadata to the database for storage.

Any of the methods above are disclosed further comprising generating, by the parsing platform, extraction metadata after extracting the target data corresponding to the individual target fields from at least one source document.

Any of the methods above are disclosed wherein the extraction metadata comprises information regarding the at least one cycle of data extraction process.

Any of the methods above are disclosed further comprising converting, by the parsing platform, the target data into relevant data formats before sending the target data to the database.

Any of the methods above are disclosed wherein the source document is at least in one or a combination of the following format: HTML, CSS, Javascript and JSON.

Any of the methods above are disclosed wherein at least one data extraction process is part of a data procurement project executed by the service provider infrastructure.

Any of the methods above are disclosed further comprising returning, by the parsing platform, the at least one source document to another queue of source documents when the at least one cycle of data extraction process fails.

Any of the methods above are disclosed further comprising utilizing, by the parsing platform, the first parsing frame and the at least one new parsing frame and repeats executing the at least one cycle of data extraction process until the parsing platform receives another at least one new parsing frame.

1. A method of extracting target data with precision by utilizing a plurality of parsing frames, the method comprises:
(a) receiving, by a parsing platform present within a service provider infrastructure, a first parsing frame from an external computing resource prior to executing at least one cycle of a data extraction process, wherein the first parsing frame comprises a list of target fields and individual target fields in the list of target fields are each coupled with a distinct string of code or a navigational guideline to aid the parsing platform in locating the target fields in at least one source document of a target;
(b) executing, by the parsing platform, the at least one cycle of the data extraction process by utilizing the first parsing frame;
(c) receiving, by the parsing platform, a second parsing frame from the external computing resource, wherein the parsing platform receives the second parsing frame at a random instance following the at least one cycle of the data extraction process;
(d) analyzing, by the parsing platform, the second parsing frame, to identify a difference between the first parsing frame and the second parsing frame;
(e) utilizing, by the parsing platform, the first parsing frame and the difference identified in (d) to execute the at least one data extraction process, wherein the utilizing (e) comprises (i) utilizing the second parsing frame to extract target data corresponding to a target field whose emplacement has been changed in the at least one source document and (ii) utilizing the first parsing frame to extract target data corresponding to a target field whose emplacement has not been changed in the at least one source document.

2. The method of claim 1, wherein the executing in said (b) comprises:
fetching, by the parsing platform, the at least one source document from a queue of source documents;
locating, by the parsing platform, individual target fields from the list of target fields in the at least one source document;
extracting, by the parsing platform, target data corresponding to the individual target fields from the list of target fields from the at least one source document; and
sending, by the parsing platform, the target data corresponding to the individual target fields to a database.

3. (canceled)

4. The method of claim 1, wherein the first parsing frame is composed by an agent that is external to the service provider infrastructure.

5. The method of claim 1, wherein the external computing resource is operated by at least one administrator of the service provider infrastructure.

6. The method of claim 1, further comprising repeating the at least one cycle of data extraction process by utilizing the first parsing frame until the parsing platform receives the second parsing frame.

7. The method of claim 6, further comprising fetching, by the parsing platform, at least one successive source document from the queue of source documents for each repetition of the at least one cycle of data extraction process by utilizing the first parsing frame.

8. The method of claim 1, wherein the reception of the second parsing frame by the parsing platform signifies at least one of:
(i) the target field whose emplacement has been changed in the at least one source document, or
(ii) a target data corresponding to a new target field.

9. The method of claim 1, wherein the second parsing frame comprises a new string of code or a navigational guideline coupled with the target field whose emplacement has been changed in the at least one source document of the target.

10. The method of claim 1, wherein the second parsing frame is composed by an agent that is external to the service provider infrastructure.

11. The method of claim 1, further comprising storing, by the parsing platform, the first parsing frame and the second parsing frame within an internal storage available in the parsing platform.

12. The method of claim 11, further comprising sending, by the parsing platform, the target data and extraction metadata to a database for storage.

13. The method of claim 12, further comprising generating, by the parsing platform, the extraction metadata after extracting the target data corresponding to the individual target fields from the at least one source document.

14. The method of claim 12, wherein the extraction metadata comprises information regarding the at least one cycle of data extraction process.

15. The method of claim 12, further comprising converting, by the parsing platform, the target data into relevant data formats before sending the target data to the database.

16. The method of claim 1, wherein a format of the source document is one or a combination of: HTML, CSS, Javascript and JSON.

17. The method of claim 1, where at least one data extraction process is part of a data procurement project executed by the service provider infrastructure.

18. The method of claim 1, further comprising returning, by the parsing platform, the at least one source document to another queue of source documents when the at least one cycle of data extraction process fails.

19. The method of claim 1, further comprising utilizing, by the parsing platform, the first parsing frame and the second parsing frame and repeats the executing the at least one cycle of the data extraction process until the parsing platform receives at least one new parsing frame.
